(19) United States
(12) Patent Application Publication
(10) Pub. No.: US 2018/0307667 A1
(43) Pub. Date: Oct. 25, 2018

(54) TRAVEL GUIDE GENERATING METHOD AND SYSTEM

(71) Applicant: Alibaba Group Holding Limited, Grand Cayman (KY)

(72) Inventors: Zhou Ye, Hangzhou (CN); Yu Wang, Hangzhou (CN); Fan Chen, Hangzhou (CN); Yang Yang, Hangzhou (CN); Nannan Du, Hangzhou (CN); Zihao Zheng, Hangzhou (CN); Jia Yu, Hangzhou (CN)

(21) Appl. No.: 16/024,442

(22) Filed: Jun. 29, 2018

Related U.S. Application Data
(63) Continuation of application No. PCT/CN2016/110232, filed on Dec. 16, 2016.

(30) Foreign Application Priority Data
Dec. 30, 2015 (CN) 201511021481.5

(51) Int. Cl. G06F 17/24; G06F 17/27; G06K 9/00; G06Q 50/14; G06F 17/30

(52) U.S. Cl. CPC G06F 17/248; G06F 17/243; G06F 17/2705; G06K 9/00664; G06F 3/04842; G06F 17/2765; G06Q 50/14; G06F 17/30864; G06F 17/273

(57) ABSTRACT

A travel guide generating method including receiving at least one keyword input by a user; matching each keyword with pre-stored travel subject terms to determine a subject category corresponding to each of the keywords; determining a current guide template from multiple guide templates according to the matching result; and automatically generating a travel guide according to the keyword and the current guide template. The travel guide generating method and system allow a user to avoid spending a lot of time and effort on writing out a travel guide, and increase the user's enthusiasm for making travel guides.

### CROSS REFERENCE TO RELATED PATENT APPLICATIONS

This application claims priority to and is a continuation of PCT Patent Application No. PCT/CN2016/110232, filed on 16 Dec. 2016, which claims priority to Chinese Patent Application No. 201511021481.5 filed on 30 Dec. 2015 and entitled “TRAVEL GUIDE GENERATING METHOD AND SYSTEM”, which are incorporated herein by reference in their entirety.

### TECHNICAL FIELD

The present disclosure relates to the field of Internet information processing, and, more particularly, to travel guide generating methods and systems.

### BACKGROUND

In current society, backpack travel has become a mainstream of the tourism market. Therefore, travel guides that guide tourists how to travel, record the feelings, and sort out and share experience after the travel play a significant role in the tourism market. Many tourism-related websites and applications on the market have collected many travel guides, allowing tourists to search for related guides and make their own guides before traveling. The tourist may also sort out travel notes and guides after the travel, and record events and feelings related to the travel, to help them remember and for helping other tourists to make plans before their travels.

In view of this, more persons spend time to make travel guides after the travels. Various tourism-related websites also sort out a massive amount of travel guides and provide recommendations. For example, guides made by some tourists are marked as favorite according to details of content, and so on. However, in the process of making a guide, writing a large amount of text is time and labor consuming. Moreover, lots of pictures taken during the travel need to be sorted out and screened, and the selection of pictures and the determining of positions of the pictures in the guides can be puzzling, which requires much time and affects the tourists' enthusiasm for making guides.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of the above problems, example embodiments of the present disclosure provide a travel guide generating method and system that may overcome the above problems or at least partially overcome the above problems.

To solve the above problems, an example embodiment of the present disclosure discloses a travel guide generating method, including the following steps:

receiving at least one keyword input by a user;

matching each keyword to pre-stored travel subject terms to determine a subject category corresponding to each of the keywords;

determining a current guide template from multiple guide templates according to the matching result; and

automatically generating a travel guide according to the keyword and the current guide template.

Another example embodiment of the present disclosure discloses a travel guide generating method, including:

providing a keyword input interface for a user to input at least one keyword;

sending the keyword input by the user to a server, so that the server determines a subject category and a guide template according to the keyword input by the user; and

receiving a travel guide generated according to the keyword and returned by the server.

Another example embodiment of the present disclosure discloses a travel guide generating system, including:

a keyword receiving module configured to receive at least one keyword input by a user;

a subject category determination module configured to match each keyword to pre-stored travel subject terms to determine a subject category corresponding to each of the keywords;

a guide template selection module configured to determine a current guide template from multiple guide templates according to the matching result; and

a travel guide generation module configured to automatically generate a travel guide according to the keyword and the current guide template.

Another example embodiment of the present disclosure discloses a travel guide generating system, including:

an input interface providing module configured to provide a keyword input interface for a user to input at least one keyword;

a keyword sending module configured to send the keyword input by the user to a server, so that the server determines a subject category and a guide template according to the keyword input by the user; and

a travel guide receiving module configured to receive a travel guide generated according to the keyword and returned by the server.

The example embodiments of the present disclosure have the following advantages:

The above-mentioned travel guide generating method and system allow a user to avoid spending a lot of time and effort on writing a travel guide, and increase the user's enthusiasm for making travel guides. For users who travel frequently and need to write travel guides in batches, the example embodiments of the present disclosure may save lots of time in making guides, thus improving the efficiency.

### BRIEF DESCRIPTION OF THE DRAWINGS

To describe the technical solutions in the example embodiments of the present disclosure, the following briefly introduces the accompanying drawings describing the example embodiments. Apparently, the accompanying drawings described in the following merely represent some example embodiments described in the present disclosure, and those of ordinary skill in the art may still derive other drawings from these accompanying drawings without creative efforts.

FIG. 1 is a flowchart of a travel guide generating method according to a first example embodiment of the present disclosure.

FIG. 2 is a flowchart of a travel guide generating method according to a second example embodiment of the present disclosure.

FIG. 3 is a flowchart of a travel guide generating method according to a third example embodiment of the present disclosure.

FIG. 4 is a flowchart of a travel guide generating method according to a fourth example embodiment of the present disclosure.

FIG. 5 is a block diagram of a travel guide generating system according to a fifth example embodiment of the present disclosure.

FIG. 6 is a block diagram of a travel guide generating system according to a sixth example embodiment of the present disclosure.

FIG. 7 is an illustrative flowchart of a travel guide generating method according to an example embodiment of the present disclosure.

FIG. 8 is a schematic diagram of input content and output content of a travel guide generating method according to an example embodiment of the present disclosure.

FIG. 9 is a block diagram of input content and output content of a travel guide generating method according to an example embodiment of the present disclosure.

### DETAILED DESCRIPTION

The technical solutions in the example embodiments of the present disclosure will be described clearly and completely with the accompanying drawings in the example embodiments of the present disclosure. Apparently, the described example embodiments merely represent some instead of all of the example embodiments of the present disclosure. Based on the example embodiments of the present disclosure, all other example embodiments derived by those of ordinary skill in the art shall all fall within the protection scope of the present disclosure.

An example method includes receiving at least one keyword input by a user; matching each keyword to pre-stored travel subject terms to determine a subject category corresponding to each of the keywords; determining a current guide template from multiple guide templates according to the matching result; and automatically generating a travel guide according to the keyword and the current guide template. The travel guide generating method and system provided in the present disclosure allow a user to avoid spending a lot of time and effort on writing out a travel guide, and increase the user's enthusiasm for making travel guides.

### First Example Embodiment

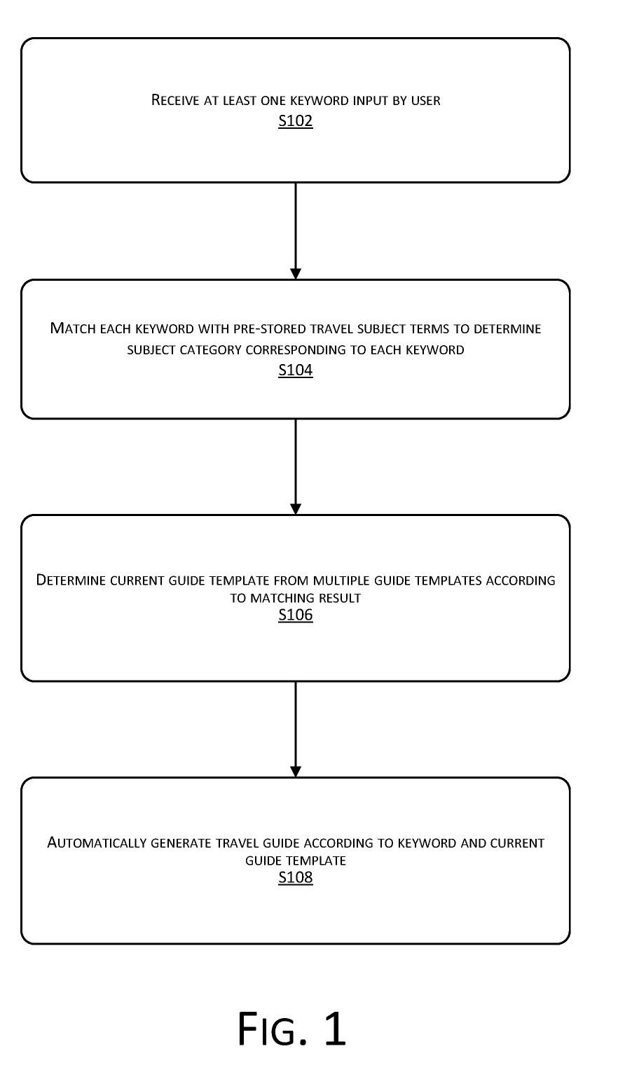

FIG. 1 is a flowchart of a travel guide generating method according to a first example embodiment of the present disclosure. As shown in FIG. 1, for example, the travel guide generating method according to the first example embodiment of the present disclosure may be applied to a server. The method includes the following steps:

Step S102: At least one keyword input by a user is received.

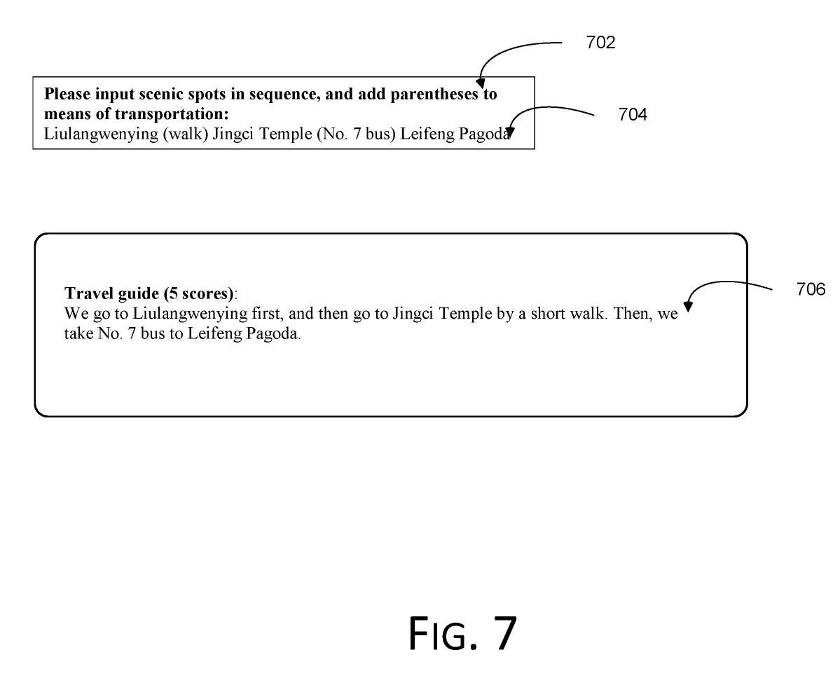

In this step, the server may receive a text input by the user. The text may have multiple keywords including, for example, travel routes, means of transportation, dining, accommodation, and the like. The user may input the text by using, for example, an information input interface. For example, FIG. 7 is a schematic diagram of input and output of a travel guide generating method according to an example embodiment of the present disclosure. A prompt 702 displayed on an information input interface of a client terminal may be “Please input scenic spots in sequence, and add parentheses to means of transportation”, to facilitate a system to recognize keywords. According to the prompt, a user may input a text 704, for example, “Liulangwenying (walk) Jingci Temple (No. 7 bus) Leifeng Pagoda”. The text includes multiple keywords: Liulangwenying, walk, Jingci Temple, No. 7 bus, Leifeng Pagoda. The client terminal sends the keywords to the server, and the server receives the keywords input by the user.

Step S104: Each keyword is matched with to pre-stored travel subject terms to determine a subject category corresponding to each keyword.

In this step, the server may pre-store multiple travel subject terms, each travel subject term corresponding to one subject category. When one of the received keywords input by the user matches one of the pre-stored travel subject terms, the subject category corresponding to the travel subject term is the subject category corresponding to the keyword. For example, one of the received keywords input by the user is “Leifeng Pagoda”, and a subject category corresponding to the travel subject term “Leifeng Pagoda” pre-stored in the server is “scenic spot”. Therefore, it may be determined that the subject category corresponding to the keyword “Leifeng Pagoda” is “scenic spot”. Another keyword input by the user is “No. 7 bus”, and a subject category corresponding to the travel subject term “No. 7 bus” pre-stored in the server is “means of transportation”. Therefore, it may be determined that the subject category corresponding to the keyword “No. 7 bus” is “means of transportation”. These travel subject terms may be pre-stored in a database on the server.

Step S106: A current guide template is determined from multiple guide templates according to the matching result.

In this step, the current guide template may be determined from multiple guide templates in the server according to the matching result of the keyword and the travel subject terms. For example, a text input by the user is “(No. 7 bus) Leifeng Pagoda”. The server recognizes that keywords included in the text are “No. 7 bus” and “Leifeng Pagoda”. Three guide templates on the server are respectively: “take ( ) to ( )”, “go to ( ) to taste ( )”, and “live in ( )”. Therefore, the first template, i.e., “take ( ) to ( )” may be selected as the current guide template according to the matching result.

Step S108: A travel guide is generated automatically according to the keyword and the current guide template.

In this step, according to the keywords “No. 7 bus” and “Leifeng Pagoda” input by the user and the current guide template “take ( ) to ( )”, the server may fill “No. 7 bus” and “Leifeng Pagoda” respectively into blank filling areas of the current guide template to automatically generate a travel guide “take No. 7 bus to Leifeng Pagoda”.

The travel guide generating method provided in the first example embodiment of the present disclosure allows a user to avoid spending a lot of time and effort on writing out a travel guide, and increase the user's enthusiasm for making travel guides. For users who travel frequently and need to write travel guides in batches, the travel guide generating method provided in the example embodiment of the present disclosure may save lots of time in making guides, thus improving the efficiency.

### Second Example Embodiment

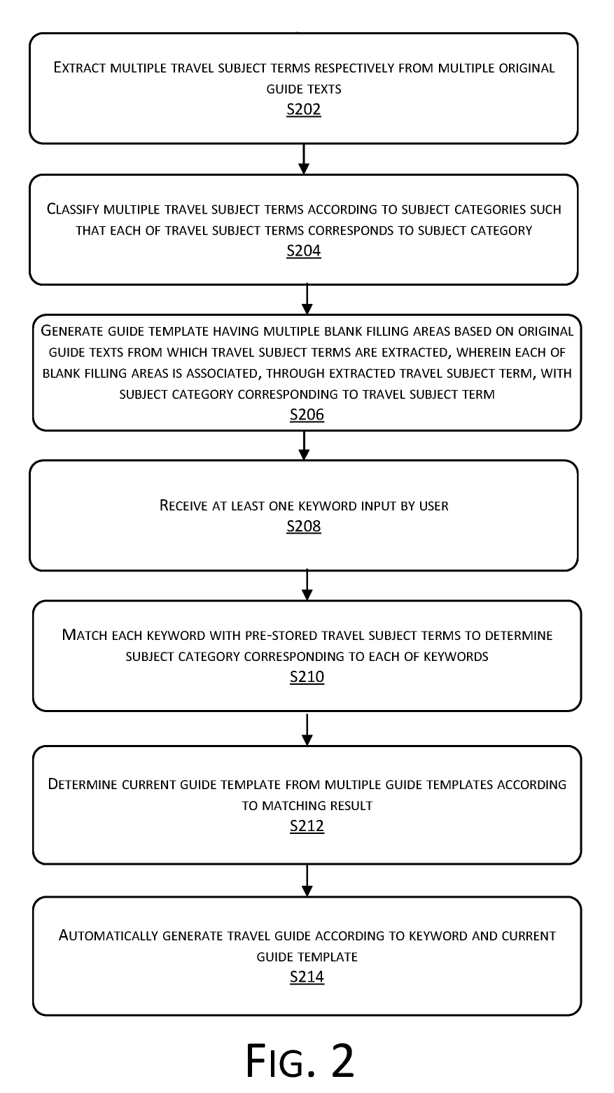

FIG. 2 is a flowchart of a travel guide generating method according to a second example embodiment of the present disclosure. As shown in FIG. 2, for example, the travel guide generating method according to the second example embodiment of the present disclosure may be applied to a server. The method includes the following steps:

S202: Multiple travel subject terms are extracted respectively from multiple original guide texts.

In this step, the multiple original guide texts may be acquired from a database on a server. The database has stored guide data in various categories. For example, if classification is made according to scenic spots of cities, the database stores data classified according to scenic spots of cities.

Travel subject terms are extracted from each original guide text, and a guide template having at least one blank filling area is formed after the travel subject terms are extracted. The travel subject terms may be extracted by recognizing nouns in the original guide text by syntactic analysis or other means.

For example, an original guide text is “Take the train to HangZhou East Railway Station, exit the railway station and take the metro to Longxiangqiao, exit the metro station and go to the lakeside on foot, and have lunch in Zhiweiguan to taste special snacks of Hangzhou. Travel along the West Lake, from Yongj in Gate to Liulangwenying, then travel Jingci Temple, Leifeng Pagoda, Prince's Bay, Su Causeway, Viewing Fish at Flower Pond, Hupao Spring, and Lithe Pagoda, finally go to the first park by No. 4 bus to view the music fountain in the West Lake third park at night, and sleep in Hangzhou Dujinsheng Hotel.”

Travel subject terms extracted from the above text input by the user include: “train”, “East Railway Station”, “metro”, “Longxiangqiao”, “lakeside”, “Zhiweiguan” “Hangzhou”, “West Lake”, “Yongjin Gate”, “Liulangwenying”, “Jingci Temple”, “Leifeng Pagoda”, “Prince's Bay”, “Su Causeway”, “Viewing Fish at Flower Pond”, “Hupao Spring”, “Lithe Pagoda”, “No. 4 bus”, “first park”, “third park”, “music fountain”, and “Dujinsheng Hotel”.

S204: The multiple travel subject terms are classified according to subject categories such that each of the travel subject terms corresponds to a subject category.

In this step, the travel subject terms may be classified into different subjects according to the subject categories. For example, “train”, “East Railway Station”, “metro”, “Longxiangqiao”, “lakeside”, “Zhiweiguan”, “West Lake”, “Yongjin Gate” may be classified into “means of transportation: train, metro”, “railway station: East Railway Station”, “station: Longxiangqiao”, “scenic spots: lakeside, West Lake, Yongjin Gate”, and “restaurant: Zhiweiguan”. The means of transportation, railway station, and scenic spots are subject terms, and the function may be implemented by using a related corpus and a currently mature information extraction method, which will not be described in detail here.

A subject corpus list may be further formed after the step of classification according to the subject categories. The subject corpus list may have the following data forms:

“Term: train, Subject: means of transportation

Term: lakeside, Subject: scenic spot

Term: Zhiweiguan, Subject: restaurant”

S206: A guide template having multiple blank filling areas is generated based on the original guide texts from which the travel subject terms are extracted, wherein each of the blank filling areas is associated, through an extracted travel subject term, with a subject category corresponding to the travel subject term.

With reference to step S202, after the travel subject terms are extracted, the guide template having multiple blank filling areas formed by extracting the travel subject terms from the original guide text is:

“Take ( ) to ( ) exit the railway station and take ( ) to ( ) exit the metro station and go to ( ) ( ), and have lunch in ( ) to taste special snacks of ( ). Travel along the ( ) from ( ) to ( ) then travel ( ), finally go to ( ) by ( ) to view ( ) at night, and sleep in ( ).”

In addition, each blank filling area is associated, through an extracted travel subject term, with a subject category corresponding to the travel subject term. For example, two blank filling areas in the first sentence of the guide template respectively correspond to travel subject terms “train” and “Hangzhou East Railway Station”. The two travel subject terms respectively correspond to subject categories “means of transportation” and “railway station”. Therefore, the subject categories associated with the two blank filling areas in the first sentence in the guide template are respectively “means of transportation” and “railway station”.

S208: At least one keyword input by the user is received.

This step is identical or similar to step S102 in the first example embodiment, and will not be repeated here.

It should be noted that step S208 may occur before any of steps S202 to S206, or may occur simultaneously with any of steps S202 to S206. The present disclosure does not limit the order of occurrence of step S208 and the mutual relations between step S208 and steps S202 to S206.

S210: Each keyword is matched with pre-stored travel subject terms to determine a subject category corresponding to each of the keywords.

This step may be identical or similar to step S104 in the first example embodiment. In this step, the pre-stored travel subject terms may be the multiple travel subject terms extracted in step S202, and the subject categories may be the subject categories formed by classifying the multiple travel subject terms in step S204. When one of the received keywords input by the user is identical to one of the pre-stored travel subject term, the subject category corresponding to the travel subject term is the subject category corresponding to the keyword.

S212: A current guide template is determined from multiple guide templates according to the matching result.

S214: A travel guide is automatically generated according to the keyword and the current guide template.

The two steps are identical or similar to steps S106 and S108 in the first example embodiment, and will not be repeated here.

In an example embodiment, the foregoing step S212, i.e., the step of determining a current guide template from multiple guide templates according to the matching result may include:

A first step of S212: A guide template including various subject categories is searched for from the multiple guide templates according to the various subject categories obtained by matching.

In this step, for example, a guide template including both the two subject categories may be screened out from all the guide templates. Still by taking the text “(No. 7 bus) Leifeng Pagoda” input by the user as an example for illustration, when the server recognizes that keywords included in the text are “No. 7 bus” and “Leifeng Pagoda”, it may be known that the subject category corresponding to “No. 7 bus” is “means of transportation” and the subject category corresponding to “Leifeng Pagoda” is “scenic spot” by matching the keywords with the travel subject terms on the server. Moreover, three guide templates on the server are respectively: “take ( ) to ( )”, “go to ( ) to taste ( ), and “live in ( )”. Moreover, in the guide template “take ( ) to ( ), the subject category corresponding to the first blank filling area is “means of transportation”, and the subject category corresponding to the second blank filling area is “scenic spot”. In the second guide template “go to ( ) to taste ( )”, the subject category corresponding to the first blank filling area is “restaurant”, and the subject category corresponding to the second blank filling area is “food”. In the third guide template “live in ( )”, the subject category corresponding to the blank filling area is “hotel”. Therefore, the server determines that the first guide template “take ( ) to ( )” is the current guide template according to the subject category corresponding to the keyword included in the text input by the user.

In an example embodiment, the foregoing step S214, i.e., the step of automatically generating a travel guide according to the keyword and the current guide template, includes:

A first step of S214: The at least one keyword is filled into the blank filling area of the current guide template according to the subject category to automatically generate the travel guide.

In this step, the selected current guide template is, for example, “take ( ) to ( )”, the subject category corresponding to the first blank filling area is “means of transportation”, and the subject category corresponding to the second blank filling area is “scenic spot”. Therefore, the keywords may be filled into the current guide template according to the subject categories to automatically generate the travel guide “take No. 7 bus to Leifeng Pagoda”.

For another example, the user may input a text on an information input interface according to a prompt “Please input scenic spots in sequence, and add parentheses to means of transportation”, and the input text is, for example, “Liulangwenying (walk) Jingci Temple (No. 7 bus) Leifeng Pagoda”. Each of the keywords input by the user may correspond to a corresponding subject category by using travel subject terms in the database, the current guide template including all the corresponding categories is selected from multiple guide templates, and the keywords input by the user are correspondingly filled into blank filling areas to automatically generate a travel guide text. The output travel guide text may be:

“We go to Liulangwenying first, and then go to Jingci Temple by a short walk. Then, we take No. 7 bus to Leifeng Pagoda.”

As yet another example embodiment, in step S2061, i.e., in the step of searching for a guide template including various subject categories from the multiple guide templates according to the various subject categories obtained by matching, each guide template has an emotional dimension score obtained according to a preset algorithm, and when there are multiple guide templates including all the corresponding subject categories, step S212 further includes:

A second step of S212: Guide templates including all the corresponding subject categories are selected from the multiple guide templates.

A third step of S212: The selected guide templates including all the corresponding subject categories are classified according to emotional dimension scores.

A fourth step of S212: Selection information of the user is received, and a guide template selected by the user is used as the current guide template.

For example, in the first step of S212, the step of acquiring an emotional dimension score for each of the guide templates according to a preset algorithm includes:

A: Three corpuses of description, direction, and degree are established, the corpuses each including entries and corresponding score parameters.

In this step, for example, a description word may be “osmanthus fragrance”, a direction word may be “rich”, and a degree word may be “very”.

B: The original guide text is decomposed into multiple clauses according to punctuations and conjunctions.

C: Each of the clauses is parsed into “description”, “direction”, and “degree” parts according to the Chinese grammar.

In this step, for example, a description word may be “osmanthus fragrance”, a direction word may be “rich”, and a degree word may be “very”.

D: An emotional dimension score of the clause is obtained based on the term in the “degree” part and the term in the “direction” part obtained after parsing with reference to the corpuses.

In this step, for example, if “very” is scored 4, the final score of the short text “the osmanthus fragrance is very rich” is +4.

E: The emotional dimension scores of the multiple clauses are normalized to obtain an emotional dimension score of the guide template obtained by decomposing the original guide text.

In this step, the foregoing normalization may be, for example, adding up scores of the clauses and averaging the scores to obtain the emotional dimension score of the entire guide template.

Because only the description words are removed from the guide template without affecting the emotion, the emotion score may be directly associated with the guide template.

For example, when multiple guide templates including all the corresponding subject categories are selected, the guide templates may be classified and displayed according to emotional dimensions, for the user to select. For example, after the user inputs “Liulangwenying (walk) Jingci Temple (No. 7 bus) Leifeng Pagoda”, guide templates having different emotion scores may be selected. For example, a first template having an emotion score of 4 may be selected to obtain the travel guide: “We go to Liulangwenying first, feeling an unlimited spring scenery. Then, we go to Jingci Temple by a short walk. The temple is very solemn, enabling us to feel a different atmosphere. In a hurry, we take No. 7 bus to Leifeng Pagoda. The tale of the White Snake is always my favorite, and I suddenly have a good mood.”

Moreover, for example, the user may also select a second template having an emotion score of 1 to obtain the travel guide: “We go to Liulangwenying first, and the scenery is not bad. Then, we go to Jingci Temple by a short walk, without any special feeling. Then, we take No. 7 bus to Leifeng Pagoda, but it is only a simple pagoda.”

The travel guide generating method provided in the second example embodiment of the present disclosure not only may automatically generate a travel guide, thus allowing a user to avoid spending a lot of time and effort on writing out a travel guide, and increasing the user's enthusiasm for making travel guides, but also may enable the user to select a corresponding emotion, such that the obtained travel guide is more humanized.

### Third Example Embodiment

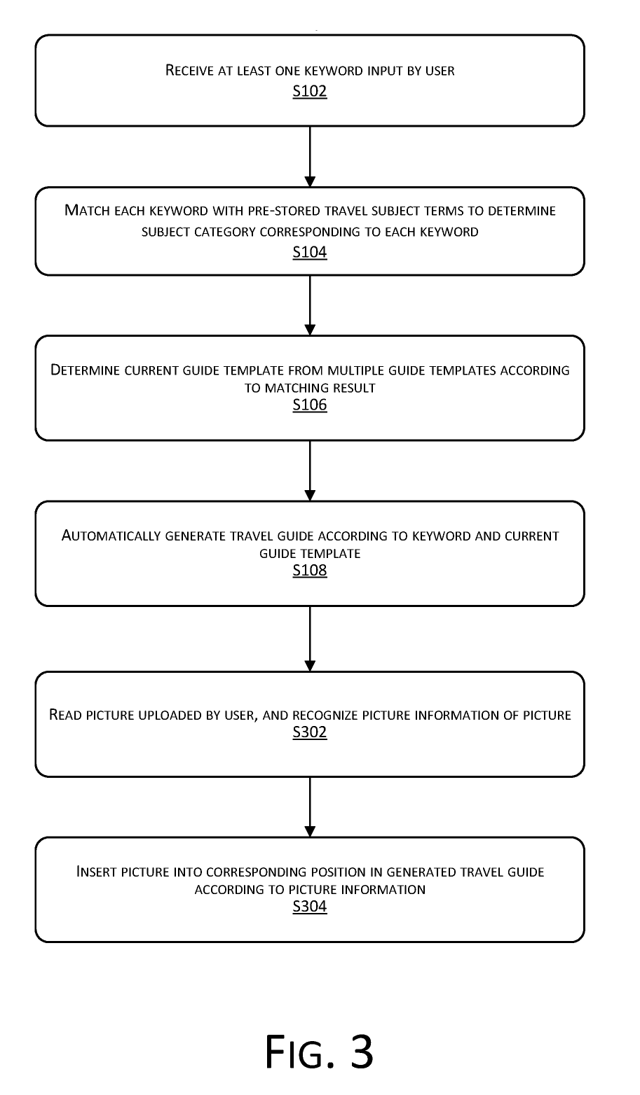

FIG. 3 is a flowchart of a travel guide generating method according to a third example embodiment of the present disclosure. As shown in FIG. 3, for example, the travel guide generating method according to the third example embodiment of the present disclosure may be applied to a server.

On the basis of steps S102 to S108 of the first example embodiment or steps S202 to S214 of the second example embodiment, this example embodiment may further add a step of filling guide pictures. For example, as shown in FIG. 3, on the basis of step S102 to S108 of the first example embodiment, the travel guide generating method may further include:

S302: A picture uploaded by the user is read, and picture information of the picture is recognized.

In this step, a picture uploaded by the user is read, and picture information of the picture is recognized. The picture information includes a location where the picture is taken, a scenic spot and/or scenery on the picture, and the location where the picture is taken, the scenic spot, and the scenery may be recognized. To implement the function, it is necessary to obtain a model after training some manually labeled data by using a Convolutional Neural Network (CNN), and recognize a corresponding scenic spot by using the model. As the technology of recognizing a picture is already a mature technology, it will not be described in detail here.

S304: The picture is inserted into a corresponding position in the generated travel guide according to the picture information.

In this step, for example, the picture may be inserted into a travel guide text according to a rule “Insert corresponding pictures under the text sequentially according to an order of occurrence of scenic spots in the text”.

For example, before the picture is inserted into the corresponding position of the travel guide text, the travel guide generating method of this example embodiment may further include the following step:

A picture with picture quality higher than a preset threshold is selected as a to-be-inserted picture.

In this step, quality scores of the pictures may be calculated, and a picture having a quality score less than the threshold is deleted. To implement the function, it is necessary to obtain a model after training some manually labeled data by using a Convolutional Neural Network (CNN), then use the model to calculate a quality score for the picture, and finally delete a picture with low quality, i.e., a picture having a quality score lower than a threshold preset by a system. The calculating the quality score of the picture is also a mature technology, and will not be described in detail here.

In this step, pictures with high quality may be screened out and inserted into the travel guide text. Meanwhile, if there is more than one picture for a scenic spot, a picture having a high picture quality score is selected for insertion. These rules may be obtained after summarizing a large number of high-quality travel guide compositions. By means of the above method, a travel guide having excellent text and pictures may be generated.

The travel guide generating method provided in the third example embodiment of the present disclosure not only may automatically generate a travel guide, thus allowing a user to avoid spending a lot of time and effort on writing out a travel guide, and increasing the user's enthusiasm for making travel guides, but also may match pictures to achieve an effect of excellent text and pictures, such that the obtained travel guide is more humanized and beautiful.

In each of the foregoing example embodiments, before each keyword is matched to pre-stored travel subject terms to determine a subject category corresponding to each of the keywords in step S104 or step S210, the travel guide generating method provided in the example embodiment of the present disclosure may further include the following step:

Text correction is performed, by using preset scenic spot data, on keywords input into the text by the user.

The preset scenic spot data may be, for example, third-party travel data, including translated names and nicknames of some place names, and may be used for correcting the text input by the user, to ensure the correctness of the travel guide. A fuzzy search technology may be adopted to implement the function, and a “fuzzy search” method may be used. In the process, a term frequency of each correct word is obtained by using high-quality travel texts (which may be crawled by a crawler), then an editing distance between a correct road name and a road name that needs to be corrected is calculated, and finally a term having the greatest “term frequency/editing distance” is selected. By means of the method, for example, “Yongjing Gate” may be corrected as “Yongjin Gate”.

In each of the foregoing example embodiments, after step S108 or step S214, i.e., the step of automatically generating a travel guide according to the keyword and the current guide template, the method may further include:

The generated travel guide is sent to the user.

In each of the foregoing example embodiments, before step 102, the solution of the present disclosure may further include classifying guide data according to specific classifications in the database. The “specific classification” here may be, for example, scenic spot.

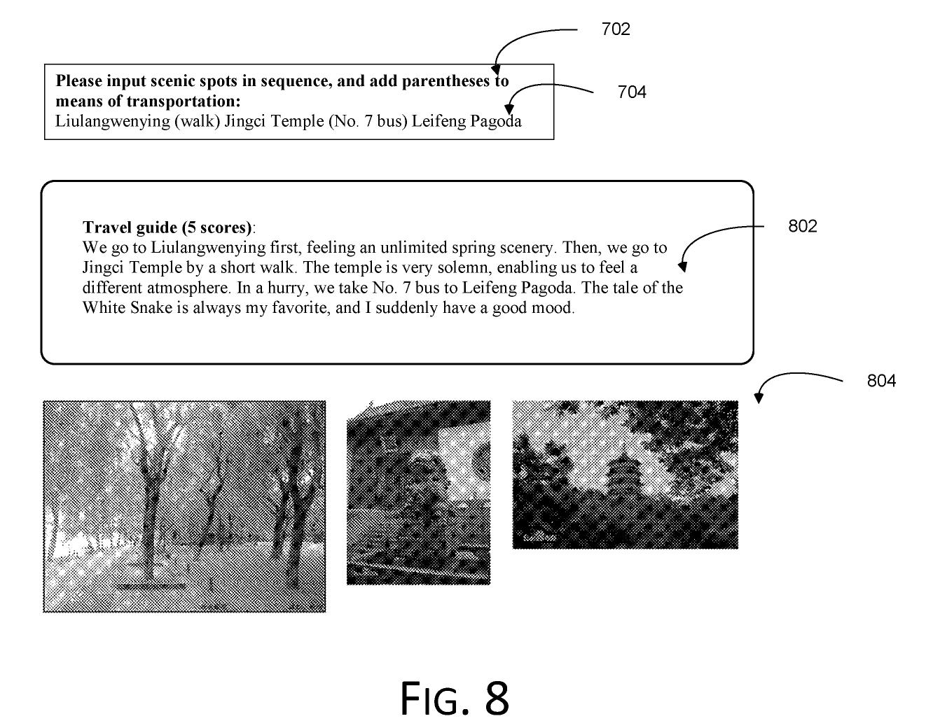

FIG. 8 is a schematic diagram of input content and output content of a travel guide generating method according to an example embodiment of the present disclosure. As shown in FIG. 8, for example, a prompt 702 displayed on an information input interface of a client terminal may be “Please input scenic spots in sequence, and add parentheses to means of transportation”, to facilitate a system to recognize keywords. According to the prompt, a user may input a text 704, for example, “Liulangwenying (walk) Jingci Temple (No. 7 bus) Leifeng Pagoda”. The text includes multiple keywords: Liulangwenying, walk, Jingci Temple, No. 7 bus, Leifeng Pagoda. According to the travel guide generating method of the present disclosure, a detailed and emotional guide 802 “We go to Liulangwenying first, feeling an unlimited spring scenery. Then, we go to Jingci Temple by a short walk. The temple is very solemn, enabling us to feel a different atmosphere. In a hurry, we take No. 7 bus to Leifeng Pagoda. The tale of the White Snake is always my favorite, and I suddenly have a good mood” is generated. Pictures 804 may also be obtained after the input of the text 704, thus improving the beauty and readability of the guide.

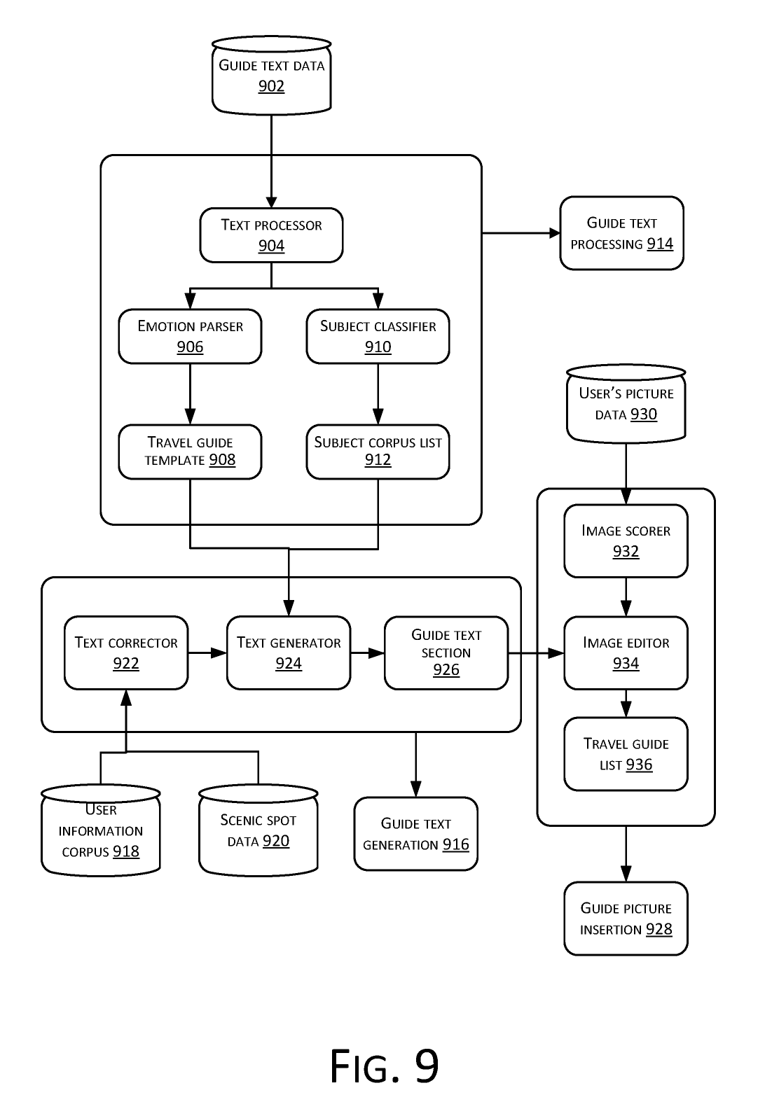

Those skilled in the art may understand that the multiple foregoing example embodiments may refer to each other or be combined, to form a new example embodiment. Moreover, the orders of the steps in the foregoing example embodiments are not particularly limited, and the solutions disclosed in the foregoing example embodiments do not particularly limit the scope of the present disclosure. For example, FIG. 9 is a schematic flowchart of a travel guide generating method according to an example embodiment of the present disclosure, which may be considered as a combination of the foregoing three example embodiments.

The travel guide generation method includes three parts, i.e., guide text processing, guide text generation, and guide picture insertion. The guide text process is to parse the original guide texts into templates and subject terms and score them. The guide text generation is to fill the tourism information input by the user into the corresponding template to generate the guide text. The guide picture filling in is to select the user's pictures and the appropriate location to input the picture into the text of the guide. Thus, one or more travel guides are finally generated with different scores in emotions for the user to select.

The original guide texts are output from guide text data 902 and input into a text processor 904. The guide text data 902 may be classified according to locations to be processed by the text processor 904. The text processor 904 parses the original guide text into subject terms and guide templates. The emotion parser 906 scores the emotions of each original guide text. As the travel guide templates 908 remove the descript words and do not affect the emotions reflected in the original guide texts. Thus, the scores in emotions are associated with the travel guide templates 908. The subject classifier 910 clusters the subject terms into different categories such as travel means, scenes, restaurants. A subject corpus list 912 is formed. This process is referred to as a guide text processing 914.

A next process is a guide text generation 916. User information corpus 918 is the travel data input by the user, such as the travel route, travel means, restaurant, lodging. Scenic spot data 920 is the travel data input by a third party, such as translations and alias of the locations, which is used by a text corrector 922 to correct the information from the user information corpus 918. A text generator 924 generates a guide text portion 926 of the travel guide based on the travel guide template 908 and the subject corpus list 912.

A following process is a guide picture insertion 928 to add corresponding pictures into the guide text section 926. The user's picture data 930 may include the travel pictures uploaded by the user, some or all of which may be placed in the corresponding positions in the travel guide. An image scorer 932 calculates the quality scores of the pictures and identifies the corresponding locations. For example, the scoring may use manually labeled data and data models which may be trained by convolutional neural network (CNN), and use the trained model to calculate the quality scores of the pictures and identify the scenes shown in the pictures. The pictures with low quality scores may be deleted. An image editor 934 inserts the pictures into the corresponding positions in the guide text section 926. For example, the pictures may be inserted into the guide text section 926 sequentially according to the appearances of the scenes represented by the pictures in the guide text section 926. If there are more than two pictures for the same scene, the pictures may be selected according to their quality scores. The output is a travel guide list 936 which includes one or more travel guides with emotion scores. The user may select a travel guide from the travel guide list 936.

Those of ordinary skill in the art may combine multiple example embodiments or learn from multiple example embodiments, to form new solutions. These solutions all fall within the protection scope of the present disclosure.

### Fourth Example Embodiment

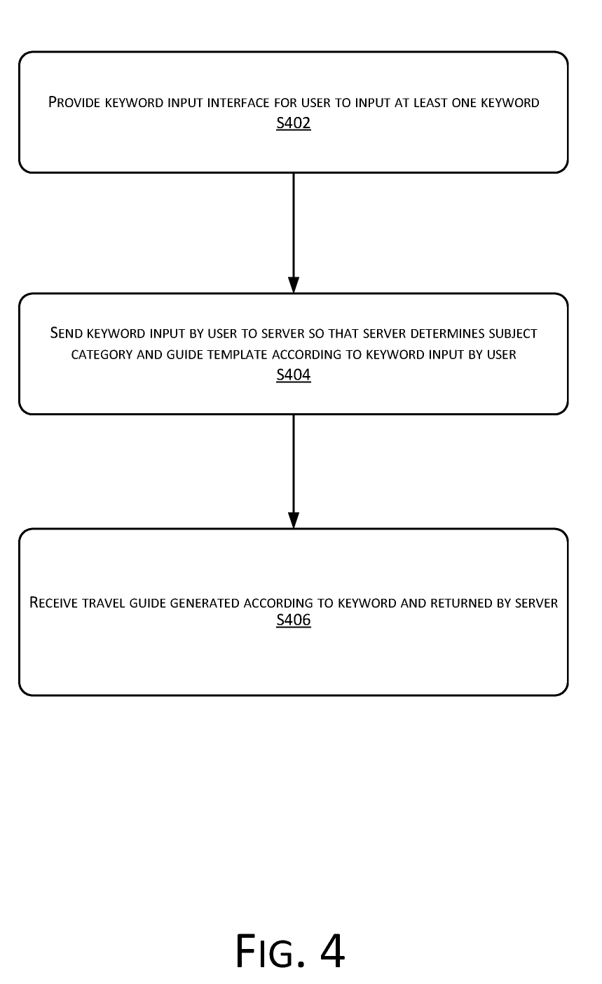

FIG. 4 is a flowchart of a travel guide generating method according to a fourth example embodiment of the present disclosure. As shown in FIG. 4, the travel guide generating method may be applied to a client terminal, and the method may include the following steps:

S402: A keyword input interface is provided for a user to input at least one keyword.

In this step, the client terminal may provide an input interface for a user to input a text. The text may have multiple keywords including, for example, travel routes, means of transportation, dining, accommodation, and the like. The user may input the text by using, for example, an information input interface. Referring to FIG. 7, for example, a prompt 702 displayed on an information input interface of a client terminal may be “Please input scenic spots in sequence, and add parentheses to means of transportation”, to facilitate a system to recognize keywords. According to the prompt, a user may input a text 704, for example, “Liulangwenying (walk) Jingci Temple (No. 7 bus) Leifeng Pagoda”. The text includes multiple keywords: Liulangwenying, walk, Jingci Temple, No. 7 bus, Leifeng Pagoda.

S404: The keyword input by the user is sent to a server, so that the server determines a subject category and a guide template according to the keyword input by the user.

In this step, the client terminal may send the keywords to the server, and the server determines the subject categories and guide templates. The server may pre-store travel subject terms, each travel subject term corresponding to one subject category. When one of the keywords input by the user and sent by the client terminal is the same as one of the pre-stored travel subject terms, the subject category corresponding to the travel subject term is the subject category corresponding to the keyword. For example, one of the keywords input by the user is “Leifeng Pagoda”, and a subject category corresponding to the travel subject term “Leifeng Pagoda” pre-stored in the server is “scenic spot”. Therefore, it may be determined that the subject category corresponding to the keyword “Leifeng Pagoda” is “scenic spot”. Another keyword input by the user is “No. 7 bus”, and a subject category corresponding to the travel subject term “No. 7 bus” pre-stored in the server is “means of transportation”. Therefore, it may be determined that the subject category corresponding to the keyword “No. 7 bus” is “means of transportation”.

In addition, the current guide template may be determined from multiple guide templates in the server according to the matching result of the keyword sent by the client terminal and the travel subject terms. For example, a text input by the user and sent by the client terminal is “(No. 7 bus) Leifeng Pagoda”. The server recognizes that keywords included in the text are “No. 7 bus” and “Leifeng Pagoda”. Three guide templates on the server are respectively: “take ( ) to ( ), “go to ( ) to taste ( )”, and “live in ( )”. Therefore, the first template, i.e., “take ( ) to ( ) may be selected as the current guide template according to the matching result.

Step 406: A travel guide generated according to the keyword and returned by the server is received.

In this step, according to the keywords “No. 7 bus” and “Leifeng Pagoda” input by the user and the current guide template “take ( ) to ( )”, the server may fill “No. 7 bus” and “Leifeng Pagoda” respectively into blank filling areas of the guide template to automatically generate a travel guide “take No. 7 bus to Leifeng Pagoda”. The client terminal may receive a travel guide generated according to the keyword and returned by the server.

For another example, as shown in FIG. 7, according to the text 704 “Liulangwenying (walk) Jingci Temple (No. 7 bus) Leifeng Pagoda” input by the user, a travel guide 706 “We go to Liulangwenying first, and then go to Jingci Temple by a short walk. Then, we take No. 7 bus to Leifeng Pagoda” may be generated.

For example, the travel guide generated according to the keyword is acquired by filling the keyword into the guide template. The guide template includes at least one blank filling area. Each blank filling area is associated with one of the subject categories. The keyword is filled into the blank filling area correspondingly according to the associated subject category.

For example, two blank filling areas in the foregoing “take ( ) to ( )” are respectively associated with subject categories “means of transportation” and “scenic spot”, and “No. 7 bus” and “Leifeng Pagoda” sent by the client terminal are respectively filled into the two blank filling areas to automatically generate a travel guide “take No. 7 bus to Leifeng Pagoda”.

For example, the subject categories are obtained by classifying multiple travel subject terms extracted respectively from multiple original guide texts, wherein each of the travel subject terms corresponds to one subject category. The guide template is generated based on the original guide texts from which the travel subject terms are extracted.

For example, an original guide text is “Take the train to HangZhou East Railway Station, exit the railway station and take the metro to Longxiangqiao, exit the metro station and go to the lakeside on foot, and have lunch in Zhiweiguan to taste special snacks of Hangzhou. Travel along the West Lake, from Yongj in Gate to Liulangwenying, then travel Jingci Temple, Leifeng Pagoda, Prince's Bay, Su Causeway, Viewing Fish at Flower Pond, Hupao Spring, and Lithe Pagoda, finally go to the first park by No. 4 bus to view the music fountain in the West Lake third park at night, and sleep in Hangzhou Dujinsheng Hotel.”

Travel subject terms extracted from the above text input by the user include: “train”, “East Railway Station”, “metro”, “Longxiangqiao”, “lakeside”, “Zhiweiguan” “Hangzhou”, “West Lake”, “Yongjin Gate”, “Liulangwenying”, “Jingci Temple”, “Leifeng Pagoda”, “Prince's Bay”, “Su Causeway”, “Viewing Fish at Flower Pond”, “Hupao Spring”, “Lithe Pagoda”, “No. 4 bus”, “first park”, “third park”, “music fountain”, and “Dujinsheng Hotel”.

The travel subject terms may be classified into different subjects according to the subject categories. For example, “train”, “East Railway Station”, “metro”, “Longxiangqiao”, “lakeside”, “Zhiweiguan”, “West Lake”, “Yongjin Gate” may be classified into “means of transportation: train, metro”, “railway station: East Railway Station”, “station: Longxiangqiao”, “scenic spots: lakeside, West Lake, Yongjin Gate”, and “restaurant: Zhiweiguan”. The means of transportation, railway station, and scenic spots are subject terms, and the function may be implemented by using a related corpus and a currently mature information extraction method, which will not be described in detail here.

A subject corpus list may be further formed after the step of classification according to the subject categories. The subject corpus list may have the following data forms:

“Term: train, Subject: means of transportation

Term: lakeside, Subject: scenic spot

Term: Zhiweiguan, Subject: restaurant”

After extracting the travel subject terms, the guide template having multiple blank filling areas formed by extracting the travel subject terms from the original guide text is:

“Take ( ) to ( ) exit the railway station and take ( ) to ( ) exit the metro station and go to ( ) ( ), and have lunch in ( ) to taste special snacks of ( ). Travel along the ( ) from ( ) to ( ) then travel ( ), finally go to ( ) by ( ) to view ( ) at night, and sleep in ( )”

In addition, each blank filling area is associated, through an extracted travel subject term, with a subject category corresponding to the travel subject term. For example, two blank filling areas in the first sentence of the guide template respectively correspond to travel subject terms “train” and “Hangzhou East Railway Station”. The two travel subject terms respectively correspond to subject categories “means of transportation” and “railway station”. Therefore, the subject categories associated with the two blank filling areas in the first sentence in the guide template are respectively “means of transportation” and “railway station”.

By means of the above method, the travel guide generating method provided in the fourth example embodiment of the present disclosure not only may automatically generate a travel guide, thus allowing a user to avoid spending a lot of time and effort on writing out a travel guide, and increasing the user's enthusiasm for making guides.

For example, in the step of providing a keyword input interface for a user to input at least one keyword, the input interface is used for displaying a designated input format.

For example, a prompt displayed on an information input interface may be “Please input scenic spots in sequence, and add parentheses to means of transportation”, to facilitate a system to recognize keywords. According to the prompt, a user may input a text, for example, “Liulangwenying (walk) Jingci Temple (No. 7 bus) Leifeng Pagoda”.

For example, in the step of sending the keyword input by the user to a server, so that the server determines a subject category and a guide template according to the keyword input by the user, there are multiple guide templates.

The step of receiving a travel guide generated according to the keyword and returned by the server includes:

receiving multiple travel guides generated according to the keyword and returned by the server.

The method further includes:

sending selection information input by the user to the server; and

receiving a travel guide that is finally selected by the user and returned by the server.

For example, when the server screens out multiple guide templates including a subject category corresponding to each keyword input by the user, the server may generate a travel guide by using each guide template, and send the travel guides to the client terminal.

When receiving the multiple travel guides, the user may select one from them as a finally selected travel guide. The client terminal sends the selection information input by the user to the server, and receives a travel guide that is finally selected by the user and returned by the server.

For example, in the step of receiving multiple travel guides generated according to the keyword and returned by the server, the method further includes:

classifying and displaying the multiple travel guides returned by the server according to an emotional dimension score associated with each of the guide templates.

In this step, each guide template is associated with an emotional dimension score, and the emotional dimension score may be obtained by steps S2061a to S2061e in the second example embodiment. In this step, the multiple travel guides returned by the server may be classified and displayed in the client terminal according to emotional dimension scores. For example, travel guides generated using guide templates scored 5 are classified into one category for display, travel guides generated using guide templates scored 4 are classified into one category for display, and so on.

For example, the travel guide generating method further includes: providing a picture input interface to upload a picture input by the user to the server.

After the picture is uploaded to the server, the step of receiving a travel guide generated according to the keyword and returned by the server includes:

receiving a travel guide including the picture input by the user and returned by the server.

That is, in this step, the server inserts the picture in the travel guide generated according to the keyword, to form a travel guide having the picture.

By means of the above method, the travel guide generating method provided in the fourth example embodiment of the present disclosure not only may automatically generate a travel guide, thus allowing a user to avoid spending a lot of time and effort on writing out a travel guide, and increasing the user's enthusiasm for making guides, but also may enable the user to select a corresponding emotion and match pictures to achieve an effect of excellent text and pictures, such that the obtained travel guide is more humanized and beautiful.

### Fifth Example Embodiment

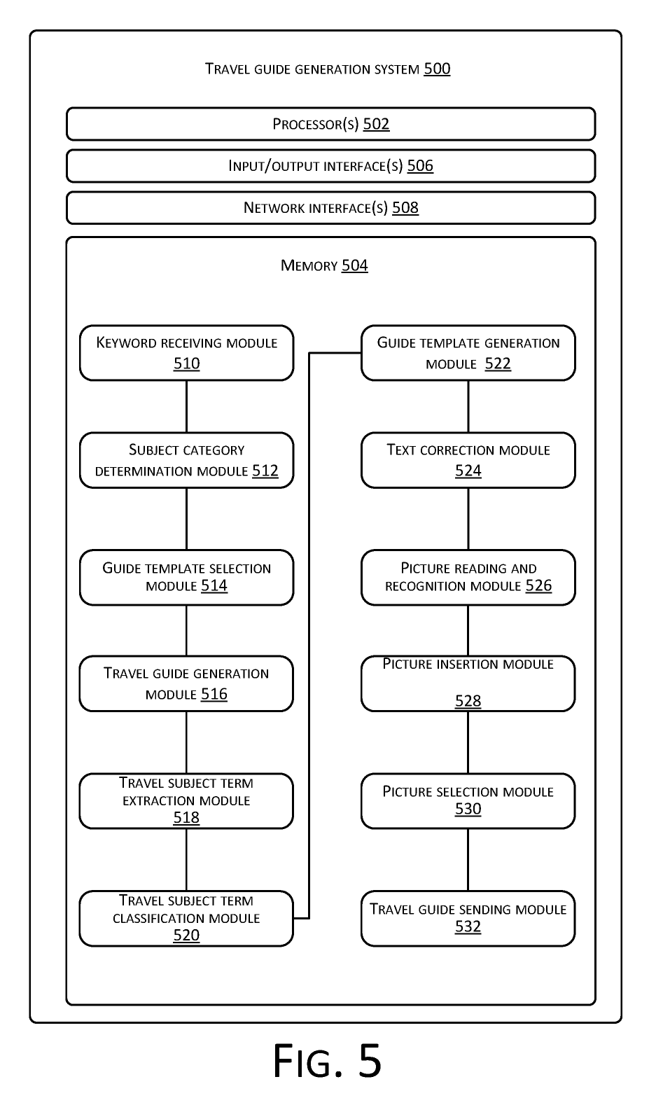

FIG. 5 shows a travel guide generating system according to a fifth example embodiment of the present disclosure. As shown in FIG. 5, the travel guide generating system 500 includes one or more processor(s) 502 or data processing unit(s) and memory 504. The travel guide generating system 500 may further include one or more input/output interface(s) 506 and one or more network interface(s) 508. The memory 504 is an example of computer readable media.

The memory 504 may store therein a plurality of modules or units including:

a keyword receiving module 510 configured to receive at least one keyword input by a user;

a subject category determination module 512 configured to match each keyword to pre-stored travel subject terms to determine a subject category corresponding to each of the keywords;

a guide template selection module 514 configured to determine a current guide template from multiple guide templates according to the matching result; and

a travel guide generation module 516 configured to automatically generate a travel guide according to the keyword and the current guide template.

In an example embodiment, the travel guide generating system further includes:

a travel subject term extraction module 518 configured to extract multiple travel subject terms respectively from multiple original guide texts;

a travel subject term classification module 520 configured to classify the multiple travel subject terms according to subject categories, such that each of the travel subject terms corresponds to one subject category; and a guide template generation module 522 configured to generate a guide template having multiple blank filling areas based on the original guide texts from which the travel subject terms are extracted, wherein each of the blank filling areas is associated, through an extracted travel subject term, with a subject category corresponding to the travel subject term.

In an example embodiment, the guide template selection module is configured to:

search for a guide template including various subject categories from the multiple guide templates according to the various subject categories obtained by matching.

In an example embodiment, the travel guide generation module is configured to:

fill the at least one keyword into the blank filling area of the current guide template according to the subject category to automatically generate the travel guide.

In an example embodiment, the travel guide generating system 500 may further includes the following modules stored on memory 504:

a text correction module 524 configured to perform text correction on the keywords by using preset scenic spot data.

In an example embodiment, each of the guide templates has an emotional dimension score obtained according to a preset algorithm.

When there are multiple guide templates including all the corresponding subject categories, the guide template selection module 514 includes:

a template selection sub-module configured to select guide templates including all the corresponding subject categories from the multiple guide templates;

a template classification sub-module configured to classify the selected guide templates including all the corresponding subject categories according to emotional dimension scores; and

a template determination sub-module configured to receive selection information of the user, and use a guide template selected by the user as the current guide template.

In an example embodiment, the travel guide generating system further includes an emotion scoring module, and the emotion scoring module includes:

a corpus establishment sub-module configured to establish three corpuses of description, direction, and degree, the corpuses each including entries and corresponding score parameters;

a text decomposition sub-module configured to decompose the original guide text into multiple clauses according to punctuations and conjunctions;

a text parsing sub-module configured to parse each of the clauses into “description”, “direction”, and “degree” parts according to the Chinese grammar;

an emotional dimension score acquisition sub-module configured to obtain an emotional dimension score of the clause based on the term in the “degree” part and the term in the “direction” part obtained after parsing with reference to the corpuses; and

a normalization sub-module configured to normalize the emotional dimension scores of the multiple clauses to obtain an emotional dimension score of the guide template obtained by decomposing the original guide text.

In an example embodiment, the travel guide generating system 500 may further includes the following modules stored on memory 504:

a picture reading and recognition module 526 configured to read a picture uploaded by the user, and recognize picture information of the picture; and

a picture insertion module 528 configured to insert the picture into a corresponding position in the generated travel guide according to the picture information.

In an example embodiment, the picture information includes a location where the picture is taken, a scenic spot and/or scenery on the picture.

In an example embodiment, the travel guide generating system 500 may further includes the following module stored on memory 504:

a picture selection module 530 configured to select a picture with picture quality higher than a preset threshold as a to-be-inserted picture.

In an example embodiment, the travel guide generating system 500 may further includes the following module stored on memory 504:

a travel guide sending module 532 configured to send the generated travel guide to the user.

The travel guide generating system provided in the fifth example embodiment of the present disclosure allows a user to avoid spending a lot of time and effort on writing out a travel guide, and increase the user's enthusiasm for making guides. For users who travel frequently and need to write travel guides in batches, the travel guide generating method provided in the example embodiment of the present disclosure may save lots of time in making guides, thus improving the efficiency.

### Sixth Example Embodiment

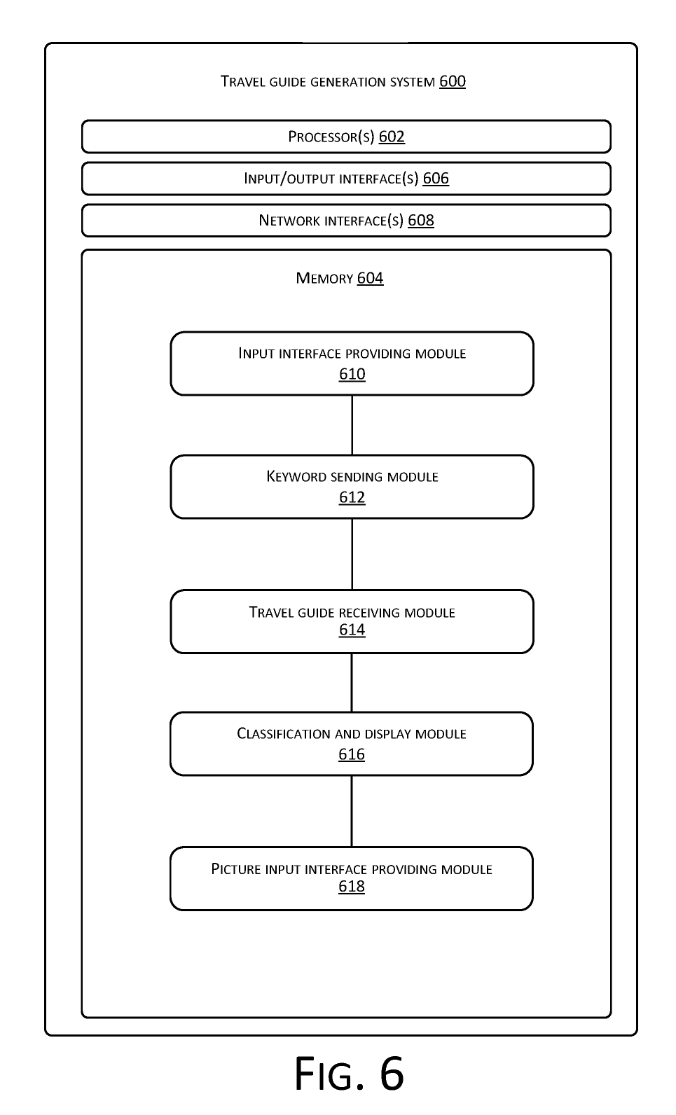

FIG. 6 is a block diagram of a travel guide generating system according to a sixth example embodiment of the present disclosure. As shown in FIG. 6, a travel guide generating system 600 includes one or more processor(s) 602 or data processing unit(s) and memory 604. The travel guide generating system 600 may further include one or more input/output interface(s) 606 and one or more network interface(s) 608. The memory 604 is an example of computer readable media.

The memory 604 may store therein a plurality of modules or units including:

an input interface providing module 610 configured to provide a keyword input interface for a user to input at least one keyword;

a keyword sending module 612 configured to send the keyword input by the user to a server, so that the server determines a subject category and a guide template according to the keyword input by the user; and

a travel guide receiving module 614 configured to receive a travel guide generated according to the keyword and returned by the server.

In an example embodiment, the travel guide generated according to the keyword is acquired by filling the keyword into the guide template. The guide template includes at least one blank filling area. Each blank filling area is associated with one of the subject categories. The keyword is filled into the blank filling area correspondingly according to the associated subject category.

In an example embodiment, the subject categories are obtained by classifying multiple travel subject terms extracted respectively from multiple original guide texts, wherein each of the travel subject terms corresponds to one subject category. The guide template is generated based on the original guide texts from which the travel subject terms are extracted.

In an example embodiment, the input interface providing module is configured to display a designated input format.

In an example embodiment, the keyword sending module is configured to send the keywords input by the user to the server, so that the server determines subject categories and multiple guide templates according to the keywords input by the user.

The travel guide receiving module 614 includes:

a primary receiving sub-module configured to receive multiple travel guides generated according to the keyword and returned by the server;

a selection information sending sub-module configured to send selection information input by the user to the server; and

a final travel guide receiving sub-module configured to receive a travel guide that is finally selected by the user and returned by the server.

In an example embodiment, the travel guide generating system 600 may further includes the following module stored on memory 604:

a classification and display module 616 configured to classify and display the multiple travel guides returned by the server according to an emotional dimension score associated with each of the guide templates.

In an example embodiment, the travel guide generating system 600 may further includes the following module stored on memory 604:

a picture input interface providing module 618 configured to provide a picture input interface to upload a picture input by the user to the server.

In an example embodiment, the travel guide receiving module 614 is configured to receive a travel guide including the picture input by the user and returned by the server.

The travel guide generating system provided in the sixth example embodiment of the present disclosure allows a user to avoid spending a lot of time and effort on writing out a travel guide, and increases the user's enthusiasm for making guides. For users who travel frequently and need to write travel guides in batches, the travel guide generating method provided in the example embodiment of the present disclosure may save lots of time in making guides, thus improving the efficiency.

The apparatus example embodiment is basically similar to the method example embodiment, and therefore is described briefly. For related parts, reference may be made to the descriptions of the parts in the method example embodiment.

The example embodiments of this specification are all described in a progressive manner, each example embodiment emphasizes a difference between it and other example embodiments, and identical or similar parts in the example embodiments may be obtained with reference to each other.

Those skilled in the art should understand that, the example embodiments of the example embodiments of the present disclosure may be provided as a method, an apparatus, or a computer program product. Therefore, the example embodiments of the present disclosure may be implemented as a complete hardware example embodiment, a complete software example embodiment, or an example embodiment combining software and hardware. Moreover, the example embodiments of the present disclosure may be a computer program product implemented on one or more computer usable storage media (including, but not limited to, a magnetic disk memory, a CD-ROM, an optical memory, and the like) including computer usable program codes.

In a typical configuration, the computer device includes one or more processors (CPU), an input/output interface, a network interface, and a memory. The memory may include a computer readable medium such as a volatile memory, a random access memory (RAM) and/or a non-volatile memory, for example, a read only memory (ROM) or a flash RAM. The memory is an example of the computer readable medium. The computer readable medium includes non-volatile and volatile media as well as movable and non-movable media, and may implement information storage by means of any method or technology. Information may be a computer readable instruction, a data structure, and a module of a program or other data. An example of the storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The example embodiments of the present disclosure are described with reference to flowcharts and/or block diagrams according to the method, terminal device (system) and computer program product according to the example embodiments of the present disclosure. It should be understood that a computer program instruction may be used to implement each process and/or block in the flowcharts and/or block diagrams and combinations of processes and/or blocks in the flowcharts and/or block diagrams. The computer program instructions may be provided to a universal computer, a dedicated computer, an embedded processor or another programmable data processing terminal device to generate a machine, such that the computer or a processor of another programmable data processing terminal device executes an instruction to generate an apparatus configured to implement functions designated in one or more processes in a flowchart and/or one or more blocks in a block diagram.

The computer program instructions may also be stored in a computer readable storage working in a specific manner in a computer or another programmable data processing terminal device, such that the instruction stored in the computer readable storage generates an article of manufacture including an instruction apparatus, and the instruction apparatus implements functions designated by one or more processes in a flowchart and/or one or more blocks in a block diagram.

The computer program instructions may also be installed in a computer or another programmable data processing terminal device, such that a series of operation steps are executed on the computer or another programmable terminal device to generate a computer implemented processing, and therefore, the instruction executed in the computer or another programmable terminal device provides steps for implementing functions designated in one or more processes in a flowchart and/or one or more blocks in a block diagram.

Example embodiments of the example embodiments of the present invention have been described. However, once knowing basic creative concepts, those skilled in the art may make other variations and modifications to the example embodiments. Therefore, the appended claims are intended to be explained as including the example embodiments and all variations and modifications falling within the scope of the example embodiments of the present disclosure.

Finally, it should be further noted that, in this text, the relation terms such as “first” and “second” are merely used to distinguish one entity or operation from another entity or operation, and do not require or imply that the entities or operations have this actual relation or order. Moreover, the terms “include”, “comprise” or other variations thereof are intended to cover non-exclusive inclusion, so that a process, method, article or terminal device including a series of elements not only includes the elements, but also includes other elements not clearly listed, or further includes inherent elements of the process, method, article or terminal device. Without any more limitations, an element defined by the expression “including a/an . . .” does not exclude that the process, method, article or terminal device including the element further has other identical elements.

A travel guide generating method and a travel guide generating system provided in the present disclosure are described above in detail, and the principles and implementation manners of the present disclosure are described by applying specific examples in this text. The above descriptions about the example embodiments are merely used to help understand the method and core ideas of the present disclosure; meanwhile, for those of ordinary skill in the art, there may be modifications to the specific implementation manners and application scopes according to the idea of the present disclosure. Therefore, the content of the specification should not be construed as limiting the present disclosure.

The present disclosure may further be understood with clauses as follows.

Clause 1. A travel guide generating method comprising:

receiving at least one keyword input by a user;

matching each keyword with pre-stored travel subject terms to determine a subject category corresponding to each keyword;

determining a current guide template from multiple guide templates according to the matching result; and

automatically generating a travel guide according to the at least one keyword and the current guide template.

Clause 2. The travel guide generating method of clause 1, wherein before the matching each keyword to the pre-stored travel subject terms, the method further comprises:

extracting multiple travel subject terms respectively from multiple original guide texts;

classifying the multiple travel subject terms according to subject categories, each of the travel subject terms corresponding to one subject category; and

generating a guide template having multiple blank filling areas based on the original guide texts from which the travel subject terms are extracted, each of the blank filling areas being associated, through an extracted travel subject term, with a subject category corresponding to the travel subject term.

Clause 3. The travel guide generating method of clause 2, wherein the determining the current guide template from the multiple guide templates according to the matching result comprises:

searching for a guide template including various subject categories from the multiple guide templates according to the various subject categories obtained by the matching.

Clause 4. The travel guide generating method of clause 3, wherein the automatically generating the travel guide according to the at least one keyword and the current guide template comprises:

filling the at least one keyword into the blank filling area of the current guide template according to the subject categories to automatically generate the travel guide.

Clause 5. The travel guide generating method of clause 1, wherein before the matching each keyword with pre-stored travel subject terms to determine the subject category corresponding to each keyword, the method further comprises:

performing text correction on the keywords by using preset scenic spot data.

Clause 6. The travel guide generating method of clause 3, further comprising:

obtaining an emotional dimension score for each of the guide templates according to a preset algorithm, wherein:

when there are multiple guide templates including all of the corresponding subject categories, the searching for the guide template including various subject categories from the multiple guide templates according to the various subject categories obtained by the matching comprises:
selecting guide templates including all of the corresponding subject categories from the multiple guide templates;
classifying the selected guide templates including all of the corresponding subject categories according to their emotional dimension scores; and
receiving selection information of the user, and using a guide template selected by the user as the current guide template.

Clause 7. The travel guide generating method of clause 6, wherein the obtaining the emotional dimension score for each of the guide templates according to the preset algorithm comprises:

establishing three corpuses including a description, a direction, and a degree, each corpuses including entries and corresponding score parameters;

decomposing an original guide text into multiple clauses according to one or more punctuations and conjunctions;

parsing each of the clauses into a part corresponding to the description, a part corresponding to the direction, and a part corresponding to the degree according to a Chinese grammar;

obtaining an emotional dimension score of each of the clauses based on a term in the part corresponding to the degree and a term in the part corresponding to the direction; and

normalizing emotional dimension scores of the multiple clauses to obtain an emotional dimension score of the guide template obtained by decomposing the original guide text.

Clause 8. The travel guide generating method of clause 1, further comprising:

reading a picture uploaded by the user, and recognizing picture information of the picture; and

inserting the picture into a corresponding position in the generated travel guide according to the picture information.

Clause 9. The travel guide generating method of clause 8, wherein the picture information comprises a location where the picture is taken, a scenic spot and/or scenery on the picture.

Clause 10. The travel guide generating method of clause 8, wherein before the inserting the picture into the corresponding position in the generated travel guide according to the picture information, the method further comprises:

selecting a picture with picture quality higher than a preset threshold as a to-be-inserted picture.

Clause 11. The travel guide generating method of any of clauses 1 to 10, further comprising:

sending the generated travel guide to the user.

Clause 12. A travel guide generating method comprising:

providing a keyword input interface for a user to input at least one keyword;

sending the at least one keyword input by the user to a server to determine one or more subject categories and guide templates according to the at least one keyword input by the user; and

receiving a travel guide generated according to the at least one keyword and returned by the server.

Clause 13. The travel guide generating method of clause 12, wherein:

the travel guide generated according to the at least one keyword is acquired by filling the at least one keyword into the guide template;

the guide template comprises at least one blank filling area, a respective blank filling area being associated with a respective subject category; and

a respective keyword is filled into the respective blank filling area correspondingly according to the associated subject category.

Clause 14. The travel guide generating method of clause 13, wherein:

the subject categories are obtained by classifying multiple travel subject terms extracted respectively from multiple original guide texts, each of the travel subject terms corresponding to one subject category; and

the guide template is generated based on the original guide texts from which the travel subject terms are extracted.

Clause 15. The travel guide generating method of clause 12, wherein the providing the keyword input interface for the user to input at least one keyword comprises displaying a designated input format at the keyword input interface.

Clause 16. The travel guide generating method of clause 12, wherein:

the sending the at least one keyword input by the user to the server to determine one or more subject categories and guide templates according to the keyword input by the user comprises providing multiple guide templates;

the receiving the travel guide generated according to the at least one keyword and returned by the server comprises receiving multiple travel guides generated according to the at least one keyword and returned by the server; and

the method further comprises:

sending selection information input by the user to the server; and

receiving a travel guide that is finally selected by the user and returned by the server.

Clause 17. The travel guide generating method of clause 16, wherein after the receiving the multiple travel guides generated according to the at least one keyword and returned by the server, the method further comprises:

classifying and displaying the multiple travel guides returned by the server according to an emotional dimension score associated with each of the guide templates.

Clause 18. The travel guide generating method of clause 12, further comprising:

providing a picture input interface to upload a picture input by the user to the server.

Clause 19. The travel guide generating method of clause 18, wherein the receiving the travel guide generated according to the at least one keyword and returned by the server comprises:

receiving a travel guide including the picture input by the user and returned by the server.

Clause 20. A travel guide generating system comprising:

a keyword receiving module configured to receive at least one keyword input by a user;

a subject category determination module configured to match each keyword with pre-stored travel subject terms to determine a subject category corresponding to each keyword;

a guide template selection module configured to determine a current guide template from multiple guide templates according to a matching result; and

a travel guide generation module configured to automatically generate a travel guide according to the keyword and the current guide template.

Clause 21. The travel guide generating system of clause 20, further comprising:

a travel subject term extraction module configured to extract multiple travel subject terms respectively from multiple original guide texts;

a travel subject term classification module configured to classify the multiple travel subject terms according to subject categories, each of the travel subject terms corresponding to a subject category; and

a guide template generation module configured to generate a guide template having multiple blank filling areas based on the original guide texts from which the travel subject terms are extracted, wherein each of the blank filling areas is associated, through an extracted travel subject term, with a subject category corresponding to the travel subject term.

Clause 22. The travel guide generating system of clause 21, wherein the guide template selection module is configured to:

search for a guide template including various subject categories from the multiple guide templates according to the various subject categories obtained by matching.

Clause 23. The travel guide generating system of clause 22, wherein the travel guide generation module is configured to:

fill the at least one keyword into the blank filling area of the current guide template according to the various subject categories to automatically generate the travel guide.

Clause 24. The travel guide generating system of clause 20, further comprising:

a text correction module configured to perform text correction on the at least one keywords by using preset scenic spot data.

Clause 25. The travel guide generating system of clause 22, wherein:

each of the guide templates has an emotional dimension score obtained according to a preset algorithm; and

when there are multiple guide templates including all of the corresponding subject categories, the guide template selection module comprises:

a template selection sub-module configured to select guide templates including all of the corresponding subject categories from the multiple guide templates;

a template classification sub-module configured to classify the selected guide templates including all of the corresponding subject categories according to emotional dimension scores; and

a template determination sub-module configured to receive selection information of the user, and use a guide template selected by the user as the current guide template.

Clause 26. The travel guide generating system of clause 25, further comprising an emotion scoring module, wherein the emotion scoring module comprises:

a corpus establishment sub-module configured to establish three corpuses including a description, a direction, and a degree, each corpuses including entries and corresponding score parameters;

a text decomposition sub-module configured to decompose an original guide text into multiple clauses according to one or more punctuations and conjunctions;

a text parsing sub-module configured to parse each of the clauses into a part corresponding to the description, a part corresponding to the direction, and a part corresponding to the degree according to a Chinese grammar;

an emotional dimension score obtaining sub-module configured to obtain an emotional dimension score of each of the clauses based on a term in the part corresponding to the degree and a term in the part corresponding to the direction; and

a normalization sub-module configured to normalize emotional dimension scores of the multiple clauses to obtain an emotional dimension score of the guide template obtained by decomposing the original guide text.

Clause 27. The travel guide generating system of clause 20, further comprising:

a picture reading and recognition module configured to read a picture uploaded by the user, and recognize picture information of the picture; and

a picture insertion module configured to insert the picture into a corresponding position in the generated travel guide according to the picture information.

Clause 28. The travel guide generating system of clause 27, wherein the picture information comprises a location where the picture is taken, a scenic spot and/or scenery on the picture.

Clause 29. The travel guide generating system of clause 27, further comprising:

a picture selection module configured to select a picture with picture quality higher than a preset threshold as a to-be-inserted picture.

Clause 30. The travel guide generating system of any of clauses 20 to 29, further comprising:

a travel guide sending module configured to send the generated travel guide to the user.

Clause 31. A travel guide generating system comprising:

an input interface providing module configured to provide a keyword input interface for a user to input at least one keyword;

a keyword sending module configured to send the at least keyword input by the user to a server to determine one or more subject categories and guide templates according to the at least one keyword input by the user; and

a travel guide receiving module configured to receive a travel guide generated according to the at least one keyword and returned by the server.

Clause 32. The travel guide generating system of clause 31, wherein:

the travel guide generated according to the keyword is acquired by filling the keyword into a guide template; and

the guide template comprises at least one blank filling area, each blank filling area being associated with one of the subject categories, and the keyword is filled into the blank filling area correspondingly according to the associated subject category.

Clause 33. The travel guide generating system of clause 32, wherein:

the subject categories are obtained by classifying multiple travel subject terms extracted respectively from multiple original guide texts, each of the travel subject terms corresponding to one subject category; and

the guide template is generated based on the original guide texts from which the travel subject terms are extracted.

Clause 34. The travel guide generating system of clause 31, wherein the input interface providing module is configured to display a designated input format.

Clause 35. The travel guide generating system of clause 31, wherein:

the keyword sending module is configured to send the at least one keyword input by the user to the server, so that the server determines subject categories and multiple guide templates according to the keywords input by the user; and

the travel guide receiving module comprises:

a primary receiving sub-module configured to receive multiple travel guides generated according to the at least one keyword and returned by the server;

a selection information sending sub-module configured to send selection information input by the user to the server; and

a final travel guide receiving sub-module configured to receive a travel guide that is finally selected by the user and returned by the server.

Clause 36. The travel guide generating system of clause 35, further comprising:

a classification and display module configured to classify and display multiple travel guides returned by the server according to an emotional dimension score associated with each of the guide templates.

Clause 37. The travel guide generating system of clause 31, further comprising:

a picture input interface providing module configured to provide a picture input interface to upload a picture input by the user to the server.

Clause 38. The travel guide generating system of clause 37, wherein the travel guide receiving module is configured to receive the travel guide including the picture input by the user and returned by the server.

What is claimed is:

1. A method comprising:
receiving at least one keyword input by a user;
matching a respective keyword with pre-stored subject terms to determine a subject category corresponding to the respective keyword;
determining a current template from multiple templates according to a result of the matching; and
automatically generating a guide according to the at least one keyword and the current template.

2. The method of claim 1, wherein:
the subject terms are travel subject terms;
the current template is a travel guide template;
the multiple templates are multiple travel guide templates;
the guide is a travel guide;

3. The method of claim 1, further comprising:
extracting multiple subject terms from multiple original guide texts;
classifying the multiple subject terms according to subject categories, a respective subject term corresponding to a respective category; and
generating a template having multiple blank filling areas based on the original guide texts from which the subject terms are extracted, a respective blank filling areas being associated, through the respective subject term, with the respective subject category.

4. The method of claim 3, wherein the determining the current template from the multiple templates according to the result of the matching includes:
searching for a guide template including various subject categories from the multiple guide templates according to the various subject categories obtained from the matching.

5. The method of claim 4, wherein the automatically generating the guide according to the at least one keyword and the current guide template includes:
filling the at least one keyword into the blank filling area of the current guide template according to the subject categories to automatically generate the guide.

6. The method of claim 3, further comprising:
obtaining an emotional dimension score for the templates according to a preset algorithm.

7. The method of claim 6, further comprising:
selecting one or more templates including all subject categories corresponding to the at least one keyword from the multiple guide templates;
classifying the selected templates according to their emotional dimension scores;
receiving selection information of the user; and
using the template selected by the user as the current template.

8. The method of claim 6, wherein the obtaining the emotional dimension score for the templates according to the preset algorithm includes:
establishing three corpuses including a description, a direction, and a degree, each corpuses including entries and corresponding score parameters;
decomposing an original guide text into multiple clauses according to one or more punctuations and conjunctions;
parsing each of the clauses into a part corresponding to the description, a part corresponding to the direction, and a part corresponding to the degree;
obtaining an emotional dimension score of each of the clauses based on a term in the part corresponding to the degree and a term in the part corresponding to the direction; and
normalizing emotional dimension scores of the multiple clauses to obtain the emotional dimension score of the template.

9. The method of claim 1, further comprising:
reading a picture;
recognizing picture information of the picture; and
inserting the picture into a corresponding position in the guide according to the picture information.

10. The method of claim 9, wherein the picture is uploaded by the user.

11. The method of claim 9, wherein the picture information includes a location where the picture is taken, a scenic spot, or a scenery in the picture.

12. The method of claim 9, further comprising:
selecting the picture with picture quality higher than a preset threshold as a to-be-inserted picture.

13. The method of claim 1, further comprising:
performing text correction on the at least one keywords by using preset data.

14. The method of claim 13, wherein the preset data includes preset scenic spot data.

15. The method of claim 1, further comprising sending the guide to the user.

16. A method comprising:
providing a keyword input interface for a user to input at least one keyword;
sending the at least one keyword to a server to determine one or more subject categories and guide templates according to the at least one keyword input by the user; and
receiving one or more guides generated according to the at least one keyword and returned by the server.

17. The method of claim 16, further comprising:
classifying and displaying the one or more guides according to an emotional dimension score associated with a respective guide template corresponding to a respective guide.

18. The method of claim 16, further comprising:
providing a picture input interface to upload a picture input by the user to the server.

19. The method of claim 18, wherein the receiving the one or more guides includes receiving a guide including the picture.

20. A system comprising:
one or more processors; and
one or more memories storing thereon computer-readable instructions that, when executed by the one or more processors, cause the one or more processors to perform acts comprising:
receiving at least one keyword input by a user;
matching a respective keyword with pre-stored travel subj ect terms to determine a respective subject category corresponding to the respective keyword;
determining a current guide template from multiple guide templates according to a result of the matching; and
automatically generating a travel guide according to the at least one keyword and the current guide template.
